(19) United States
(12) Patent Application Publication
(10) Pub. No.: US 2026/0197364 A1
(43) Pub. Date: Jul. 9, 2026

(54) METHOD, ELECTRONIC DEVICE AND PROGRAM PRODUCT FOR DATA REPLICATION

(71) Applicant: Dell Products L.P., Round Rock, TX (US)

(72) Inventors: Jie Huang, Chengdu (CN); Guoping Guan, Chengdu (CN); Xingxin Li, Chengdu (CN)

(21) Appl. No.: 19/268,052

(22) Filed: Jul. 14, 2025

(30) Foreign Application Priority Data
Jan. 6, 2025 (CN) 202510018484.0

(51) Int. Cl. H04L 67/1095; H04L 47/70; H04L 67/61

(52) U.S. Cl. CPC H04L 67/1095; H04L 47/70; H04L 67/61

(57) ABSTRACT

Data replication techniques involve determining a total replication bandwidth based on a plurality of replication sessions. The plurality of replication sessions are used to replicate data. Such techniques further involve comparing the total replication bandwidth with a replication link bandwidth. Such techniques further involve prioritizing, in response to the total replication bandwidth being greater than the replication link bandwidth, the plurality of replication sessions based on one or more of a user-defined priority, a differential data priority, a data change rate priority, a replication progress priority, a replication session start time priority, and a lost recovery point objective (RPO) priority. Such techniques further involve performing the data replication based on the plurality of ranked replication sessions.

### CROSS-REFERENCE TO RELATED APPLICATION

This application claims priority to Chinese Patent Application No. CN202510018484.0, on file at the China National Intellectual Property Administration (CNIPA), having a filing date of Jan. 6, 2025, and having “METHOD, ELECTRONIC DEVICE AND PROGRAM PRODUCT FOR DATA REPLICATION” as a title, the contents and teachings of which are herein incorporated by reference in their entirety.

### TECHNICAL FIELD

Embodiments of the present disclosure relate to the field of computers, and more specifically, to a method, an electronic device, and a product for data replication.

### BACKGROUND

With the exponential growth of data, diversified data processing, and hybrid cloud environment development and support, in order to meet the needs of diversified data storage, it is required to provide high-performance hardware, intelligent software, and flexibly extended architecture to provide storage solutions.

Cloud-based storage services can achieve seamless migration and management of data between the local and cloud for enterprises or individuals, while supporting cloud back-up and disaster recovery of data replicas. Storage capacity can be dynamically increased according to growth requirements, without frequent replacement of hardware, thereby reducing the cost of operation and maintenance.

### SUMMARY OF THE INVENTION

The embodiments of the present disclosure provide a method, an electronic device, and a program product for data replication.

According to a first aspect of the present disclosure, a method for data replication is provided. The method includes determining a total replication bandwidth based on a plurality of replication sessions, where the plurality of replication sessions are used to replicate data. The method further includes comparing the total replication bandwidth with a replication link bandwidth. The method further includes prioritizing, when the total replication bandwidth is greater than the replication link bandwidth, the plurality of replication sessions based on one or more of a user-defined priority, a differential data priority, a data change rate priority, a replication progress priority, a replication session start time priority, and a lost recovery point objective (RPO) priority; and performing data replication based on the plurality of ranked replication sessions.

According to a second aspect of the present disclosure, an electronic device for data replication is provided. The device includes at least one processor, and a memory coupled to the at least one processor and having instructions stored thereon, where the instructions, when executed by the at least one processor, cause the electronic device to perform actions including: determining a total replication bandwidth based on a plurality of replication sessions, where the plurality of replication sessions are used to replicate data. The method further includes comparing the total replication bandwidth with a replication link bandwidth. The actions further include prioritizing, when the total replication bandwidth is greater than the replication link bandwidth, the plurality of replication sessions based on one or more of a user-defined priority, a differential data priority, a data change rate priority, a replication progress priority, a replication session start time priority, and a lost recovery point objective (RPO) priority, and performing data replication based on the plurality of ranked replication sessions.

According to a third aspect of the present disclosure, a computer program product is provided, which is tangibly stored on a non-volatile computer-readable medium and includes machine-executable instructions, wherein the machine-executable instructions, when executed, cause a machine to perform steps of the method implemented in the first aspect of the present disclosure.

### BRIEF DESCRIPTION OF THE DRAWINGS

By description of example embodiments of the present disclosure in more detail in connection with the accompanying drawings, the above and other objectives, features, and advantages of the present disclosure will become clearer, where in the example embodiments of the present disclosure, the same reference numerals generally represent the same elements.

FIG. 1 illustrates a schematic diagram of a system where a device and/or a method according to an embodiment of the present disclosure can be implemented and used for data replication according to an embodiment of the present disclosure;

FIG. 2 illustrates a flow chart of a method for data replication according to an embodiment of the present disclosure;

FIG. 3 illustrates a flow chart of replication bandwidth allocation according to some embodiments of the present disclosure;

FIG. 4 illustrates a schematic diagram of performing a replication bandwidth allocation process for ranked replication sessions;

FIG. 5 illustrates an experimental result diagram about a total lost RPO according to an embodiment of the present disclosure;

FIG. 6 illustrates an experimental result diagram about total synchronization data according to an embodiment of the present disclosure;

FIG. 7 illustrates an experimental result diagram about a total amount of bandwidth according to an embodiment of the present disclosure;

FIG. 8 illustrates an experimental result diagram about the total number of synchronization rounds according to an embodiment of the present disclosure;

FIG. 9 illustrates an experimental result diagram about a total IO amount of a front-end host on a source site according to an embodiment of the present disclosure;

FIG. 10 illustrates another experimental result diagram about a total lost RPO according to an embodiment of the present disclosure;

FIG. 11 illustrates another experimental result diagram about total synchronization data according to an embodiment of the present disclosure;

FIG. 12 illustrates another experimental result diagram about a total amount of bandwidth according to an embodiment of the present disclosure;

FIG. 13 illustrates another experimental result diagram about the total number of synchronization rounds according to an embodiment of the present disclosure;

FIG. 14 illustrates another experimental result diagram about a total IO amount of a front-end host on a source site according to an embodiment of the present disclosure;

FIG. 15 illustrates still another experimental result diagram about a total lost RPO according to an embodiment of the present disclosure;

FIG. 16 illustrates still another experimental result diagram about total synchronization data according to an embodiment of the present disclosure;

FIG. 17 illustrates still another experimental result diagram about a total amount of bandwidth according to an embodiment of the present disclosure;

FIG. 18 illustrates still another experimental result diagram about the total number of synchronization rounds according to an embodiment of the present disclosure;

FIG. 19 illustrates still another experimental result diagram about a total IO amount of a front-end host on a source site according to an embodiment of the present disclosure; and

FIG. 20 illustrates a schematic block diagram of an example device that can be used to implement an embodiment of the present disclosure.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

In some scenarios, each replication session uses similar bandwidth or almost the same speed to replicate data. This replication method lacks the flexibility in control. The importance of data between replication sessions in a system cannot be distinguished, and the flexibility and selectivity to meet different replication requirements are lacking. This situation limits the ability of users to generate effective data protection strategies.

In some scenarios, a Recovery Point Objective (RPO) representing the maximum acceptable data loss is set to a fixed time interval. This also makes it challenging to ensure that RPOs are met, especially when different sessions replicate data at the same bandwidth regardless of different data protection requirements and I/Os.

In some scenarios, critical data becomes more vulnerable during a disaster if critical replication sessions are not prioritized. In some scenarios, a back-up system lacks the awareness to coordinate and allocate bandwidth for each session, resulting in inefficient use of resources and difficulties in meeting RPOs. In some scenarios, the back-up system may not take into account changes in the data in a source object, especially in the case where data changes suddenly increase, which may delay the replication and result in significant data loss during a disaster. An excessive replication time may also result in lost RPOs, resource exhaustion, and system downtime.

To this end, the present disclosure provides a method for data replication, and the method includes determining a total replication bandwidth based on a plurality of replication sessions, where the plurality of replication sessions are used to replicate the data. Then, the total replication bandwidth may be compared with a replication link bandwidth. When the total replication bandwidth is greater than the replication link bandwidth, the plurality of replication sessions may be prioritized based on a plurality of factors (factors such as a user-defined priority, a differential data priority, a data change rate priority, a replication progress priority, a replication session start time priority, and a lost recovery point objective (RPO) priority), and finally, data replication may be performed based on the plurality of ranked replication sessions. By using the method of the embodiments of the present disclosure, important data can be replicated preferentially, thereby minimizing data replication losses and enhancing overall data protection.

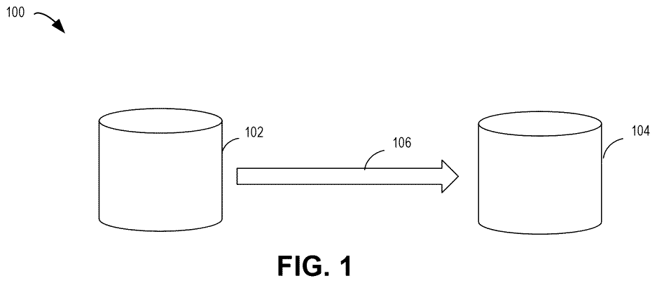

The basic principles and several example embodiments of the present disclosure will be described in detail below with reference to the drawings. FIG. 1 illustrates a schematic diagram of a process 100 where a device and/or a method according to an embodiment of the present disclosure can be implemented and used for data replication according to an embodiment of the present disclosure. It should be understood that the number and arrangement of objects, components, and elements shown in FIG. 1 are only examples, and the schematic diagram may include components, elements and nodes, objects, and various additional elements with different numbers and arrangements.

As shown in FIG. 1, a user may create one or a plurality of replication sessions between a source data center or a source site 102 and a target data center or remote site 104, and may select limited data replication strategies and parameters, such as selecting a synchronous replication mode or an asynchronous replication mode. As an example, the source data center or source site 102 may be a primary storage node for storing raw data, for processing business requests from an enterprise or company. The source data center 102 may generate a replication session and select a data set that needs to be replicated. According to the embodiments of the present disclosure, the target data center or remote site 104 may receive data replicated from the source data center 102 for back-up, disaster recovery, and subsequent business expansion.

In some embodiments, the source data center 102 may then transmit data blocks to the target data center 104 via a replication link 106 base on the data replication strategies. For example, according to some embodiments of the present disclosure, in a synchronous mode, data may be written simultaneously at the source data center 102 and the target data center 104, thereby ensuring the real-time consistency. In an asynchronous mode, the data is first written to the source data center 102 and then transmitted in batches to the target data center 104.

In some scenarios, a total replication bandwidth for the plurality of replication sessions to be replicated may be much larger than an actual bandwidth of the replication link 106, resulting in the inability to complete the replication of the plurality of replication sessions within the set time. Accordingly, the total replication bandwidths may be prioritized based on a number of factors according to the method implemented in the present disclosure.

According to the embodiments of the present disclosure, these factors may include, but are not limited to, a user-defined priority, a differential data priority, a data change rate priority, a replication progress priority, a replication session start time priority, a lost recovery point objective (RPO) priority, and so on. The data replication is then performed based on the plurality of ranked replication sessions, thereby achieving preferential replication of important data, meeting the flexibility and selectivity of different replication requirements, achieving efficient resource use, and ultimately achieving adaptive priority-based replication bandwidth allocation.

According to the embodiments of the present disclosure, the source data center 102 or the target data center 104 may be any computing device with processing computing resources or storage resources. For example, the computing device may have common abilities, such as receiving and sending data requests, real-time data analysis, local data storage, and real-time network linkage. The computing device may typically include various types of devices. Examples of the computing device may include, but are not limited to, a database server, a rack server, a server cluster, a desktop computer, a laptop, or the like, and the present disclosure does not impose any limitations thereon.

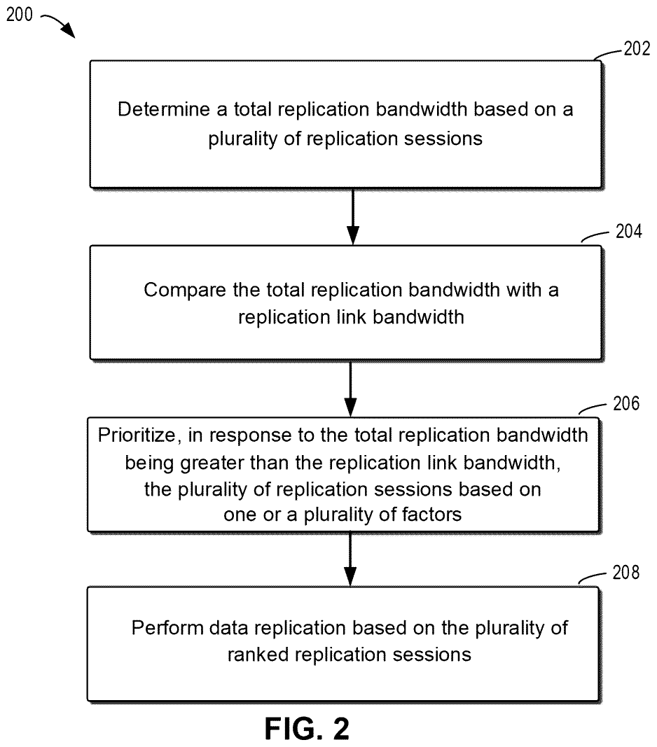

The block diagram of an environment in which some embodiments of the present disclosure can be implemented has been described above with reference to FIG. 1. A flow chart of a method 200 for data replication according to an embodiment of the present disclosure will be described below with reference to FIG. 2. The method 200 may be performed at the data center 102 or the target data center 104 in FIG. 1.

At a block 202, a total replication bandwidth is determine based on a plurality of replication sessions. According to the embodiment of the present disclosure, the source data center 102 may determine the total replication bandwidth to be replicated based on factors such as the total bandwidth required by the plurality of replication sessions currently created with the target data center 104 for data replication, the amount of data to be transmitted, etc. For example, in some embodiments, each session may determine the required replication bandwidth according to the amount of data to be transmitted and the time of data replication, and the total bandwidth may be a sum of the required bandwidths for these sessions. According to some embodiments of the present disclosure, the total replication bandwidth may be the sum of bandwidths of various sessions, and the bandwidth of each session is determined by the amount of data and the replication time.

At a block 204, the total replication bandwidth is compared with a replication link bandwidth. According to embodiments of the present disclosure, the source data center 102 may compare the total replication bandwidth to be replicated with a total replication link bandwidth of the replication link 106.

At a block 206, the plurality of replication sessions are prioritized based on a plurality of factors in response to the total replication bandwidth being greater than the replication link bandwidth. According to some embodiments of the present disclosure, when the source data center 102 determines that the total replication bandwidth is greater than the replication link bandwidth, the source data center 102 may prioritize the current replication sessions based on a number of factors that affect replication, and these factors may include, but are not limited to, a user-defined priority, a differential data priority, a data change rate priority, a replication progress priority, a replication session start time priority, a lost recovery point objective (RPO) priority, and so on.

At a block 208, data replication is performed based on the plurality of ranked replication sessions, and bandwidth is allocated to the sessions. In some embodiments, a replication rate may be controlled by allocating the bandwidth to the plurality of replication sessions based on the ranking. According to some embodiments of the present disclosure, the source data center 102 may prioritize allocation of bandwidth to high-priority replication sessions based on the ranking, so as to meet the RPO. Therefore, important data can be replicated preferentially, thereby minimizing data replication losses and enhancing overall data protection.

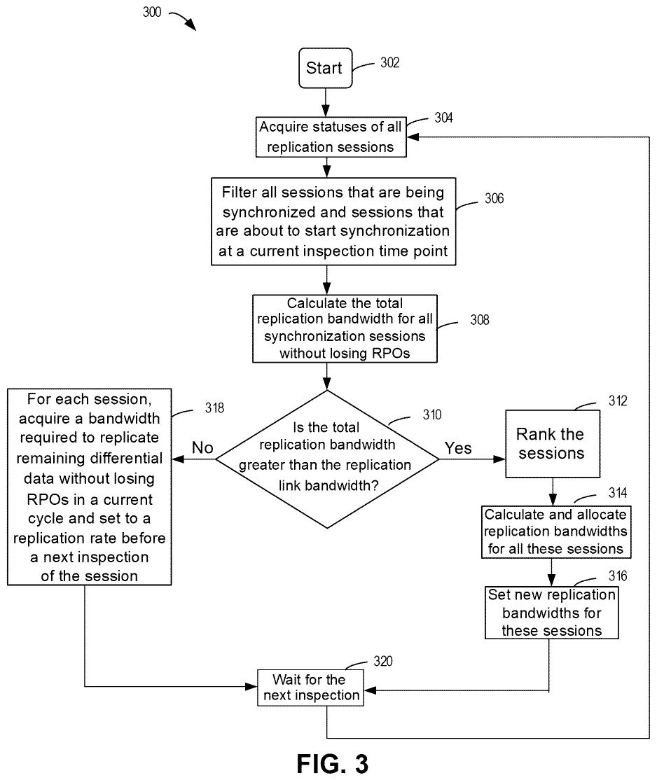

FIG. 3 illustrates a flow chart of replication bandwidth allocation according to some embodiments of the present disclosure. By means of an adaptive replication bandwidth allocation method 300 implemented in the present disclosure, sessions can be ranked according to a variety of factors, so that the top-ranked replication sessions complete data replication as much as possible, and possible loss of RPOs occur in low-ranked replication sessions. In the embodiment of the present disclosure, a replication session can replicate critical data from a primary storage device to a remote device or replica site located in a different geographic location. When a failure or data loss occurs in the primary site or primary storage device, the replica site can take over quickly, thereby ensuring that business is not interrupted.

The process may start at a block 302, and according to the embodiment of the present disclosure, an inspection process may be a periodic operation to inspect the progress, status, and synchronization requirements of all current replication sessions in a replication system.

At a block 304, statuses of all the replication sessions may be obtained, for example, inspecting current statuses of all the replication sessions, identifying which replication sessions are being synchronized, and which replication sessions are in a wait state or about to enter a synchronization phase. In some embodiments, for each asynchronous replication session, when a new replication cycle starts, it replicates differential data generated in the previous cycle to the remote. All sessions that are being synchronized or are about to be synchronized share the same replication link, which may limit the maximum replication bandwidth for all sessions.

As an example, Total_Replication_BW that represents the total bandwidth requirements for all replication sessions may be

$$Total\_Replication \_BW = {\sum }_{i = 1}^{N} {Replication\_BW}_{i} \leq Replication\_Link \_BW \qquad ( 1 )$$

where Replication_BWᵢ is the bandwidth required by the ith replication session. Replication_Link_BW is the maximum bandwidth of the entire replication link between a replication source site and a remote site (assuming that this is a dedicated replication network). N is the total number of replication sessions.

At a block 306, all sessions that are being synchronized and sessions that are about to start synchronization may be filtered at a current inspection time point. In some embodiments, the sessions being synchronized and the sessions scheduled for synchronization at the current time point may be filtered out from all sessions.

At a block 308, the total replication bandwidth required for all synchronization sessions without losing RPOs may be calculated. In some embodiments, the required bandwidth can be calculated for all sessions that need to be synchronized, and it is ensured that these sessions complete replication while meeting RPO requirements. The RPO limit means that the data of each session should be synchronized within the specified time, and therefore, the allocation of bandwidth should meet the specified time requirements.

As an example, the bandwidth Replication_BWᵢ required by the ith replication session without losing the RPO can be expressed as:

$${Replication\_BW}_{i} = \frac{Data\_to {\_Replicate}_{i}}{{Replication\_Duraction}_{i}} \qquad ( 2 )$$

where when a replication cycle starts, the ith data amount to be replicated is Data_to_Replicateᵢ, and Replication_Durationᵢ is the time for completing the replication required by the ith replication session.

In some embodiments, an initial bandwidth of each replication session when the replication cycle starts can be expressed as:

$${Replication\_BW}_{i} = \frac{Data\_to {\_Replicate}_{i}}{{RPO}_{i}} \qquad ( 3 )$$

RPOᵢ is the recovery point objective for the ith session and represents the maximum allowable time for data loss (for example, minutes or hours).

In some embodiments, a bandwidth of each replication session after the replication cycle starts can be expressed as:

$${Replication\_BW}_{i} = \frac{Left\_Data \_to {\_Replicate}_{i}}{Left\_Sync {\_Time}_{i}} \qquad ( 4 )$$

where Left Data_to_Replicateᵢ is the amount of data that has not yet been replicated to the remote site. Left_Sync_Timeᵢ is the remaining synchronization time.

Therefore, the total replication bandwidth Total_Replication_BW for all sessions can be expressed as:

$$Total\_Replication \_BW = {\sum }_{i = 1}^{N} {Replication\_BW}_{i} = {\sum }_{i = 1}^{N} \frac{Left\_Data \_to {\_Replicate}_{i}}{Left\_Sync {\_Time}_{i}} \qquad ( 5 )$$

At a block 310, it may be determined whether the total bandwidth Total_Replication_BW is greater than the replication link bandwidth. In some embodiments, if the required total bandwidth Total_Replication_BW is less than or equal to the replication link bandwidth Replication_Link_BW(Total_Replication_BW≤Replication_Link_BW), it indicates that the replication link can replicate data of all the sessions without losing RPOs.

According to the embodiment of the present disclosure, at a block 318, for each session, a bandwidth required to replicate remaining differential data without losing RPOs in a current cycle may be acquired, and the bandwidth is set to the rate of data replication before the next inspection of the session.

In some embodiments, if the required total bandwidth Total_Replication_BW is greater than the replication link bandwidth Replication_Link_BW(Total_Replication_BW>Replication_Link_BW), it indicates that some sessions may not replicate its differential data within the RPO time length.

At a block 312, the replication sessions may be sorted or ranked. For example, ranking may be performed based on factors such as priority, urgency (that is, how long a session is away from an RPO target), or other business-related priorities.

Specifically, the sessions may be ranked before the replication bandwidth is allocated for all the replication sessions. According to the embodiment of the present disclosure, six sub-scores may be determined for each synchronization session or session to be synchronized.

For example, in some embodiments, a sub-score 1 may be a user-defined priority. For example, a user may set expected priorities for all sessions. The priority may be high, medium, or low. The higher the priority, the higher the user's expectation for better data protection and the lower the probability of losing RPO. For example, the sub-score 1 score₁ may be expressed as

$${score}_{1} = \{ \begin{matrix}1 , & If user\_defined \_priority = low \\ 2 , & If user\_defined \_priority = medium \\ 3 , & If user\_defined \_priority = high\end{matrix} \qquad ( 6 )$$

In some embodiments, a sub-score 2 may be a differential data priority. For example, in some embodiments, all synchronization sessions or replication sessions that are about to be synchronized are ranked from least to more based on initial differential data of the current replication cycle. A session with the least differential data will have a ranking ID 1, the next replication session with more differential data will have a ranking ID 2, and so on. Replication sessions with the same differential data will have the same ranking.

For example, the sub-score 2 score₂ may be expressed as

$${score}_{2} = log ( {rank}_{i} ) + 1 , i = 1 , 2 , … , N \qquad ( 7 )$$

where N is the number of sessions.

In some embodiments, a sub-score 3 may be a data change rate priority. During data replication, a host or primary site may write new data to a source volume, thereby creating differential data to be replicated during the next replication cycle. In some embodiments, sessions with high write bandwidth in the source volume may have a higher priority to complete the current replication cycle, so that a large number of differences to be replicated in the next cycle can be replicated without delay.

According to the embodiment of the present disclosure, all synchronization sessions or sessions to be synchronized may be ranked from low to high based on an average write IO rate during the current replication cycle. The ranking of a session with the lowest average write IO rate is ID 1, the ranking of a next session with a higher write IO rate is ID 2, and so on. Sessions with the same host IO rate have the same ranking.

For example, the sub-score 3 score₃ may be expressed as

$${score}_{3} = log ( {rank}_{i} ) + 1 , i = 1 , 2 , … , N \qquad ( 8 )$$

In some embodiments, a sub-score 4 may be a replication progress priority. According to the embodiment of the present disclosure, different replication sessions may have different replication start times, so that the sessions may have different replication progresses when acquiring the session statuses and calculating the replication bandwidth allocation. Some sessions may just start their new replication cycles, while some sessions are about to complete their current cycles. That is, sessions that are about to complete their current cycles will have higher priorities in the bandwidth allocation.

All synchronization sessions or sessions to be synchronized may be ranked from low to high according to the replication progresses during the current replication cycle. The ranking of a session with the minimum progress is ID 1, the ranking of a next session with a higher progress is ID 2, and so on. Sessions with the same replication progress will have the same ranking.

For example, the sub-score 4 score₄ may be expressed as

$${score}_{4} = log ( {rank}_{i} ) + 1 , i = 1 , 2 , … , N \qquad ( 9 )$$

In some embodiments, a sub-score 5 may be a start time of the current replication cycle or a replication session start time priority. In some embodiments, a session whose current replication cycle starts early may have a higher priority in bandwidth allocation. This may prevent resource shortages in a session that starts early but scores lower in other aspects.

For example, all synchronization sessions or sessions to be synchronized are ranked according to the start times of the current replication cycle. The ranking of a session with the latest start time is ID 1, the ranking of the next session with an earlier start time is ID 2, and so on. Sessions with the same start time have the same ranking.

For example, the sub-score 5 scores may be expressed as

$${score}_{5} = log ( {rank}_{i} ) + 1 , i = 1 , 2 , … , N \qquad ( 10 )$$

In some embodiments, a sub-score 6 may be a lost RPO count or an RPO priority for the current replication cycle.

According to the embodiment of the present disclosure, a low-ranked session has a low replication bandwidth and is expected to have a lost RPO, but the RPO would not be lost all the time. Therefore, if a session having a low replication bandwidth is selected and once RPO loss occurs, it may have a higher priority to allocate the bandwidth, so as to complete the replication within the next cycle. When it completes the data replication, its lost RPO count may be reset to 0.

In this way, it may prevent low-priority sessions from being unable to complete the replication task for long periods of time during data replication (the RPOs have not been met). By dynamically adjusting the priority, it may be ensured that these sessions, in the event of an unmet RPO, are able to obtain bandwidth resources in time in the next replication cycle and complete the data synchronization.

In some embodiments, all synchronization sessions or sessions to be synchronized may be ranked from small to large based on the lost RPO count in the current replication cycle. The ranking of a session with the minimum lost RPO count is ID 1, the ranking of the next session with a larger lost RPO count is ID 2, and so on. Sessions with the same lost RPO count will have the same ranking.

For example, the sub-score 6 score₆ may be expressed as

$${score}_{6} = {2}^{( {rank}_{i} - 1 )} , i = 1 , 2 , … , N \qquad ( 11 )$$

According to the embodiment of the present disclosure, a product of the six scores may be calculated as a total score for each session, and then the sessions are ranked in descending order according to the total scores. Replication bandwidth allocation will depend on this ranking.

For example, the total score Total_Scoreᵢ of the ith replication session may be expressed as:

$${Total\_Score}_{i} = {Score}_{1} * {Score}_{2} * {Score}_{3} * {Score}_{4} * {Score}_{5} * {Score}_{6} \qquad ( 12 )$$

In some embodiments, sessions with the same total score may be ranked according to sub-scores. For example, the sub-scores may be ranked in an order of a score 3, a score 1, a score 5, a score 4, and a score 2.

According to the embodiment of the present disclosure, the first compared sub-score may be the score 3. A session with a higher score 3 will be allocated more bandwidth first. If the score 3 is the same, the score 1 is then compared, and so on.

Finally, if the score 2 is still the same, RPOs of the sessions are compared. A session with a smaller RPO will have a higher priority. If sessions have the same RPO, they will have the same priority and share the bandwidth equally.

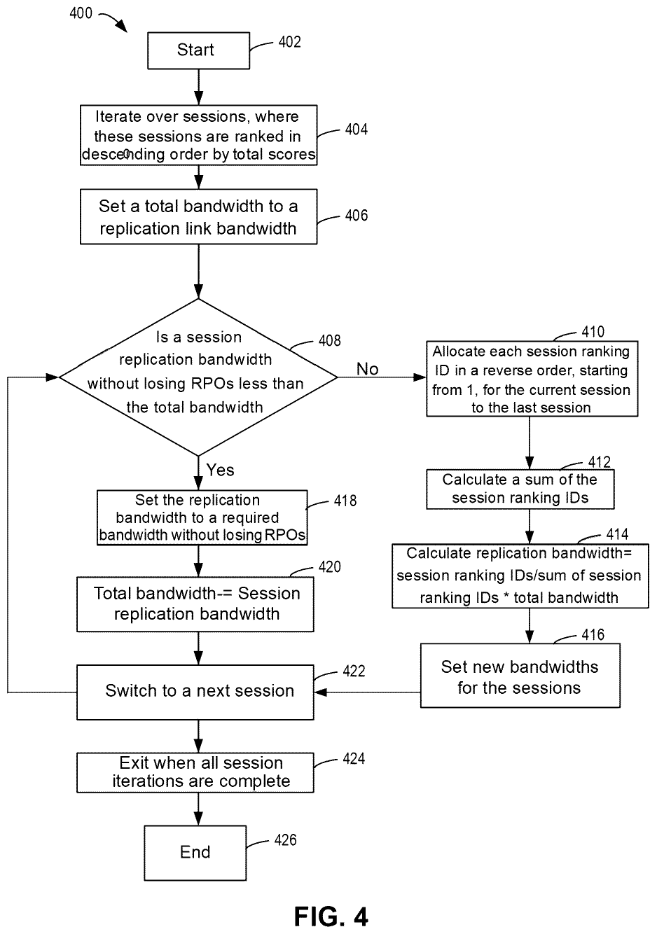

At a block 314, the bandwidth may be calculated and allocated. For example, the bandwidth may be recalculated and allocated for individual sessions based on ranking results. In some embodiments, more urgent sessions may be prioritized for the allocation to avoid loss of RPOs. Detailed steps about the allocation will be described in detail with reference to FIG. 4.

At a block 316, new replication bandwidths may be set for these replication sessions. For example, in some embodiments, new bandwidths are allocated for these sessions based on the results of the calculations, thereby ensuring that high-priority sessions are able to obtain sufficient bandwidth resources. At a block 320, it may wait for the next inspection. When the new bandwidth allocation is complete, it may wait for the next inspection cycle again to re-evaluate the synchronization requirements.

FIG. 4 illustrates a schematic diagram of performing a replication bandwidth allocation process 400 for ranked replication sessions. At each checkpoint j, if no RPO loss occurs, the total replication bandwidth Total_Replication_BWⱼ may be calculated (refer to Formula (5)). If the total replication bandwidth Total_Replication_BWⱼ is greater than the replication link bandwidth Replication_Link_BW, this means that they need more bandwidth than the replication link bandwidth to replicate data without losing the RPOs. In other words, some sessions cannot complete data replication within the RPO time.

This occurs in a scenario where too much changed data of some sessions needs to be replicated within the RPO time. If all sessions share the replication bandwidth equally, these sessions may fail to complete data replication within their RPO time and will have lost RPOs. Accordingly, the replication bandwidth may be allocated according to the order of the session scores, and the bandwidth may be set to a rate at which the data is replicated before the next inspection.

At a block 402, an allocation process may start. At a block 404, iteration may be performed over sessions, where these sessions are ranked in descending order based on total scores. At a block 406, a total bandwidth may be set to a replication link bandwidth. At a block 408, it may be determined whether a session replication bandwidth without losing RPOs is less than the total bandwidth.

For example, starting from the session with the highest total score, if its required replication bandwidth (calculated according to Formula (4)) without losing RPOs is less than the maximum allocatable bandwidth, at a block 418, its replication bandwidth at the next inspection interval may be set to the value. At a block 420, meanwhile, the bandwidth allocated to this session is subtracted from the maximum allocatable replication bandwidth. At a block 422, it may switch to the next session and then process the next session, and the above steps are repeated until all sessions are traversed at a block 424, and the process ends at a block 426.

In some embodiments, if its required replication bandwidth without losing RPOs is greater than the maximum allocatable replication bandwidth, the bandwidth expected by the session cannot be allocated. Subsequent sessions starting from this session may have lost RPOs. The remaining allocatable replication bandwidth may be allocated among these sessions according to ranking proportions, taking into account the priorities determined by their total scores.

For example, at a block 410, for the current session to the last session, each session ranking ID may be allocated in a reverse order, starting from 1. At a block 412, a sum of the ranking IDs of all the sessions may be calculated. At a block 414, the replication bandwidth may be determined as the session ranking ID/sum of session ranking IDs*total bandwidth. At a block 416, the new bandwidth is set to the session, thereby allocating a new replication bandwidth for the current session. At a block 422, it may switch to the next session and then process the next session, and the above steps are repeated until all sessions are traversed at a block 424, and the process ends at a block 426.

For example, specifically, in one embodiment, there may be five sessions S1, S2, S3, S4, and S5. When ranking in descending order based on total scores, their order may be S3, S2, S5, S4, and S1. Bandwidths for respective sessions to replicate remaining differential data without losing RPOs are B3, B2, B5, B5, and B1, respectively.

After the bandwidth B3 is allocated to a session S3, and B2 is allocated to S2, the remaining available bandwidth BW_{available} is insufficient for S5. Therefore, for the sessions S5, S4, and S1, ranking IDs are granted to them in a reverse order, starting from 1 (that is, S1: 1, S4: 2, and S5: 3). For example, in some embodiments, the replication bandwidth allocation may be S1: 1/6*BW_{available}; S4: 2/6*BW_{available}; and S5: 3/6*BW_{available}.

Additionally or alternatively, in some embodiments, if the total replication bandwidth Total_Replication_BWⱼ is less than or equal to the replication link Replication_Link_BW, it indicates that the replication link bandwidth is sufficient enough for all the sessions to replicate data without losing RPOs. In this case, the replication rate of the session may be updated (calculated by Formula (4)) by using the replication rate required for the session to complete the remaining differential data in the remaining replication time.

According to the embodiment of the present disclosure, the efficiency of the implementation of the present disclosure may be evaluated by a plurality of evaluation parameters. In some embodiments, an evaluation parameter 1 may be a percentage of reduced lost RPOs, which may be expressed as

$$\frac{fixed\_missing \_rpo - adaptive\_missing \_rpo}{fixed\_missing \_rpo} \qquad ( 13 )$$

It indicates a percentage of reduced lost RPO windows between the method prior to the testing period and the method implemented in the present disclosure. A higher value indicates that fewer RPO windows are lost.

In some embodiments, an evaluation parameter 2 may be a percentage of reduced cumulative host IOs, which may be expressed as:

$$\frac{fixed\_cumulative \_hostIO - adaptive\_cumulated \_hostIO}{fixed\_cumulative \_hostIO} \qquad ( 14 )$$

It indicates a percentage of reduced cumulative front-end host IOs between the method prior to the testing period and the method implemented in the present disclosure. A higher value indicates that fewer cumulative host IOs need to be tracked and replicated in the next RPO window.

In some embodiments, an evaluation parameter 3 may be a percentage of increased synchronization data, which may be expressed as:

$$\frac{adaptive\_synced \_data - fixed\_synced \_data}{fixed\_synced \_data} \qquad ( 15 )$$

It indicates a percentage of increased synchronization data amount between the method prior to the testing period and the method implemented in the present disclosure. A higher value indicates more synchronization data.

In some embodiments, an evaluation parameter 4 may be a percentage of increased synchronization bandwidth usage rate, which may be expressed as:

$$\frac{adaptive\_sync \_be \_usage - fixed\_sync \_bw \_usage}{fixed\_sync \_bw \_usage} \qquad ( 16 )$$

It indicates a percentage of increased replication bandwidth usage rate between the method prior to the testing period and the method implemented in the present disclosure. A higher value indicates a higher replication bandwidth usage rate.

In some embodiments, an evaluation parameter 5 may be a percentage of increased number of synchronization rounds, which may be expressed as:

$$\frac{adaptive\_sync \_rounds - fixed\_sync \_rounds}{fixed\_sync \_rounds} \qquad ( 17 )$$

It indicates a percentage of increased number of synchronization rounds between the method prior to the testing period and the method implemented in the present disclosure. A higher value indicates more completed replication synchronization rounds.

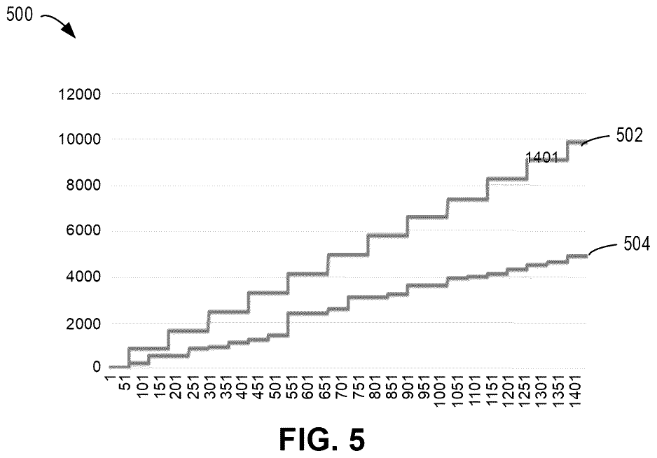

FIG. 5 to FIG. 9 of the embodiments of the present disclosure show cases where the total bandwidth required for the sessions is greater than the link bandwidth. FIG. 5 illustrates an experimental result 500 about a total lost RPO according to an embodiment of the present disclosure. In the following experiment scenario, parameters of the experiment may be 1000 replication sessions, replication RPO of 5 minutes, and duration of 120 minutes, and the total bandwidth allocated may be greater than/less than/equal to the replication link bandwidth.

As shown in FIG. 5, in a scenario where the total bandwidth required for the sessions is greater than the link bandwidth, the method 504 implemented according to the present disclosure has fewer RPOs lost, while the previous method 205 has more RPOs lost on the timeline. The fewer RPOs lost result in the less pressure the system has to handle the lost RPO event, and the less time window for data loss.

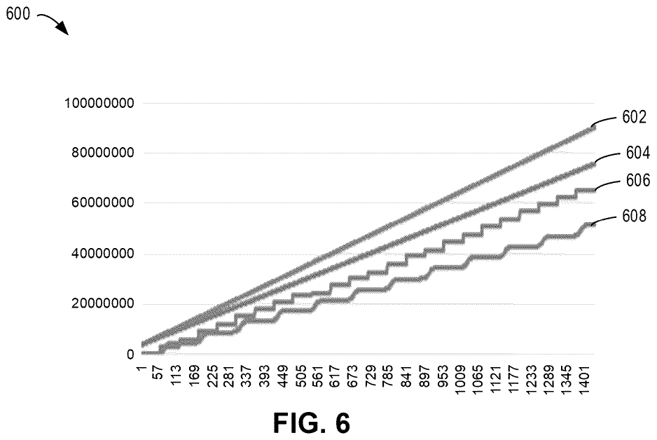

FIG. 6 illustrates an experimental result 600 about total synchronization data according to an embodiment of the present disclosure. In FIG. 6 for exploring total synchronization data, the total bandwidth 602 required for the sessions is greater than the replication link bandwidth 604. The total synchronization data 606 of the adaptive method implemented in the present disclosure is always greater than that of the previous method 608 and is closer to the link bandwidth over time. The more data is replicated, the less data is lost when a disaster occurs.

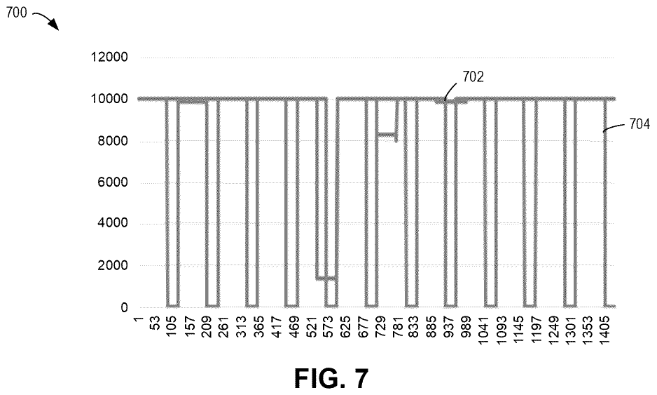

FIG. 7 illustrates an experimental result 700 about a total amount of bandwidth according to an embodiment of the present disclosure. Total bandwidth usage measures a replication link bandwidth used by the replication sessions. The bandwidth used by an adaptive replication bandwidth 702 implemented according to the present disclosure is almost equal to the replication link bandwidth, but the bandwidth used by a fixed replication bandwidth 704 has some problems and the usage drops to zero. As a result, the closer to the link bandwidth, the higher the bandwidth usage is.

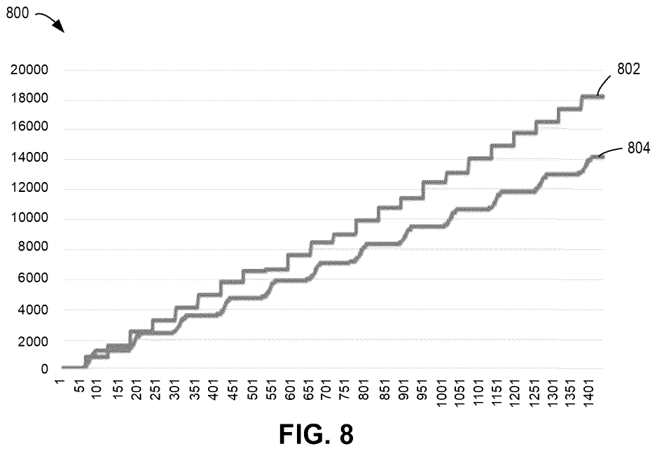

FIG. 8 illustrates an experimental result 800 about the total number of synchronization rounds according to an embodiment of the present disclosure. In the diagram of total number of synchronization rounds, an adaptive total number of synchronization rounds 802 implemented according to the present disclosure is always higher than that of a fixed method 804. More completed cycles of synchronization will result in more consistent data, and more consistent data recovery in the event of a disaster.

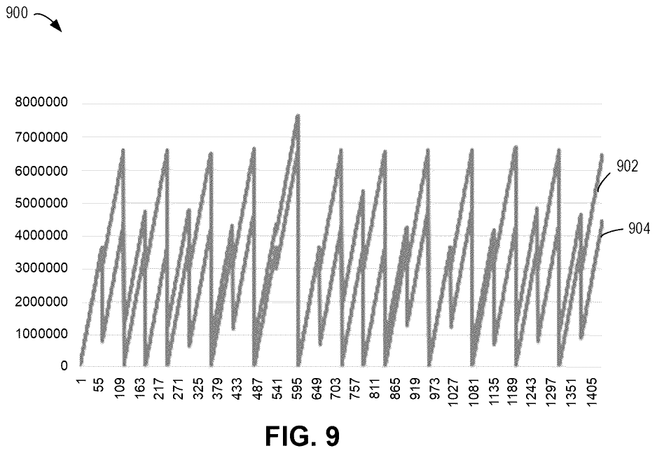

FIG. 9 illustrates an experimental result 900 about a total IO amount of a front-end host on a source site according to an embodiment of the present disclosure. The host IO total data of an adaptive method 904 implemented according to the embodiments of the present disclosure is smoother and more controllable than that of a fixed method 902, and an average value on the timeline is lower than that of the fixed method 902. A smoother, more controllable line indicates that fewer resources may be used to track and replicate the cumulative host IOs of the next RPO window without failure.

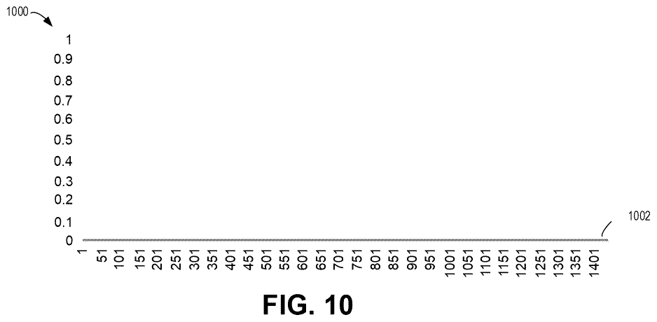

FIG. 10 to FIG. 14 show cases where the total bandwidth required for the sessions is less than the link bandwidth. FIG. 10 illustrates another experimental result 1000 about a total lost RPO according to an embodiment of the present disclosure. An adaptive method implemented according to the present disclosure is equal to a fixed method 1002, and does not lose any RPO on the timeline. They have consistent performance for this situation without any degradation.

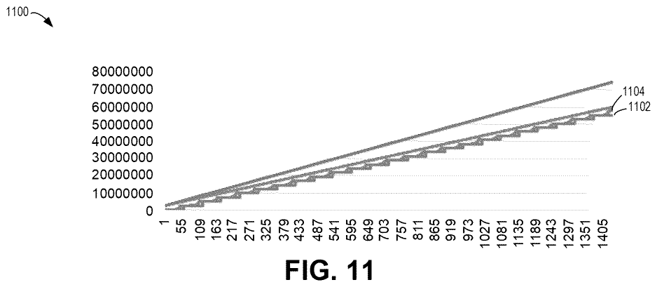

FIG. 11 illustrates another experimental result 1100 about total synchronization data according to an embodiment of the present disclosure. Total synchronization data of an adaptive method 1102 implemented according to the present disclosure is almost equal to that of a fixed method 1104. The two have consistent performance for this situation without any degradation.

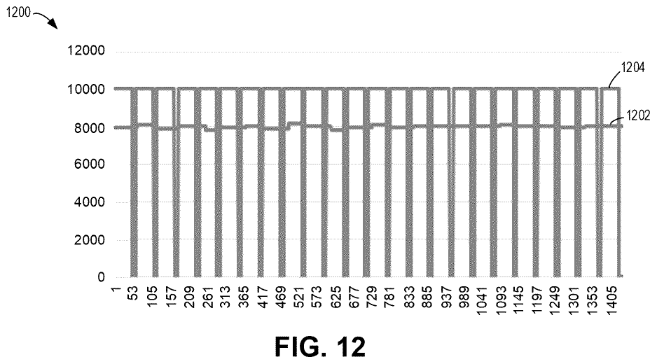

FIG. 12 illustrates another experimental result 1200 about a total amount of bandwidth according to an embodiment of the present disclosure. The bandwidth used by the adaptive method 1202 implemented according to the present disclosure is lower than the replication link bandwidth, but the bandwidth used by the fixed method 1204 has some problems, it drops to zero usage, and almost uses only the total replication link bandwidth of the timeline, and the bandwidth required by the actual session is less than the replication link bandwidth. Therefore, the adaptive replication bandwidth method implemented according to the present disclosure will release more idle bandwidth for use by the system.

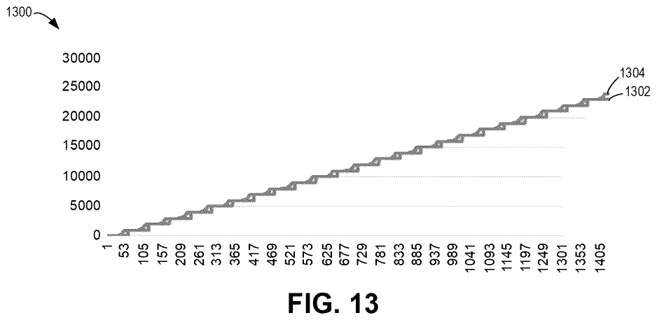

FIG. 13 illustrates another experimental result 1300 about the total number of synchronization rounds according to an embodiment of the present disclosure. In the diagram of total number of synchronization rounds, the number of synchronization rounds of an adaptive method 1302 implemented according to the present disclosure is equal to that of a fixed method 1304 on the timeline (there may be some time lag due to the purpose of releasing more idle bandwidth in the new solution). They have consistent performance for this situation without any degradation.

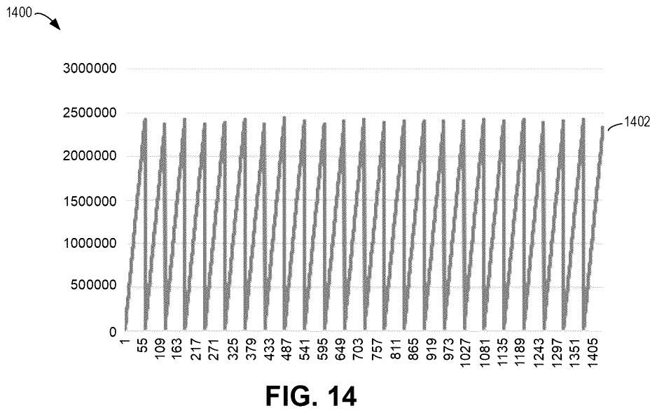

FIG. 14 illustrates another experimental result 1400 about a total IO amount of a front-end host on a source site according to an embodiment of the present disclosure. The total cumulative host IO data of an adaptive method implemented according to the embodiments of the present disclosure is equal to that of a fixed method 1402, and they have consistent performance for this situation without any degradation.

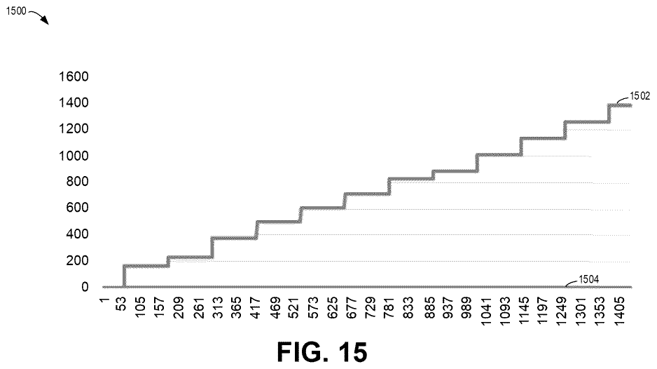

FIG. 15 to FIG. 19 show cases where the total bandwidth required for the sessions is equal to the link bandwidth. FIG. 15 illustrates still another experimental result 1000 about a total lost RPO according to an embodiment of the present disclosure. An adaptive replication bandwidth method 1504 implemented according to the embodiments of the present disclosure does not have any lost RPO as compared with a fixed-RPO method 1502 that has a large number of lost RPOs on the timeline, because in some cases the link bandwidth with some idle time slots cannot be fully utilized, which results in some sessions having lost RPO events. The fewer RPOs lost result in the less pressure the system required to handle the lost RPO event, and the less time window for data loss.

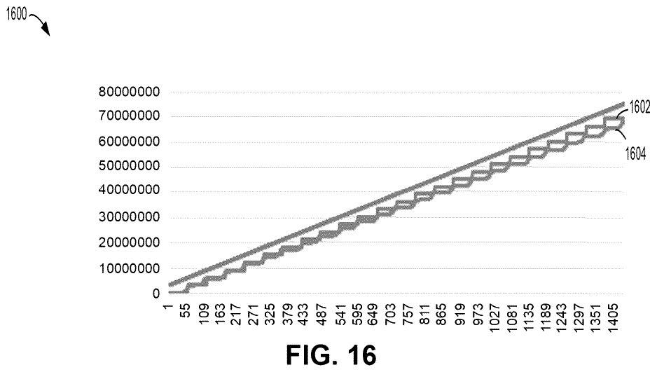

FIG. 16 illustrates still another experimental result 1600 about total synchronization data according to an embodiment of the present disclosure. Total synchronization data of an adaptive replication bandwidth method 1602 implemented according to the embodiments of the present disclosure is always greater than that of a fixed replication bandwidth method 1604 and closer to the link bandwidth on the timeline. The more data is replicated, the less data is lost in the event of a disaster.

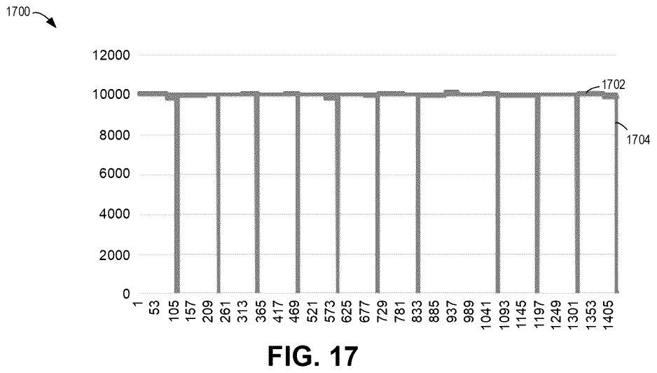

FIG. 17 illustrates still another experimental result 1700 about a total amount of bandwidth according to an embodiment of the present disclosure. The total bandwidth usage rate of the replication session using the bandwidth of the replication link is measured. An adaptive method 1702 implemented according to the embodiments of the present disclosure uses a bandwidth that is almost equal to the replication link bandwidth, but the bandwidth used by a fixed replication bandwidth method 1704 has some problems and it reduces to zero usage. As a result, the closer to the link bandwidth, the higher the bandwidth usage is.

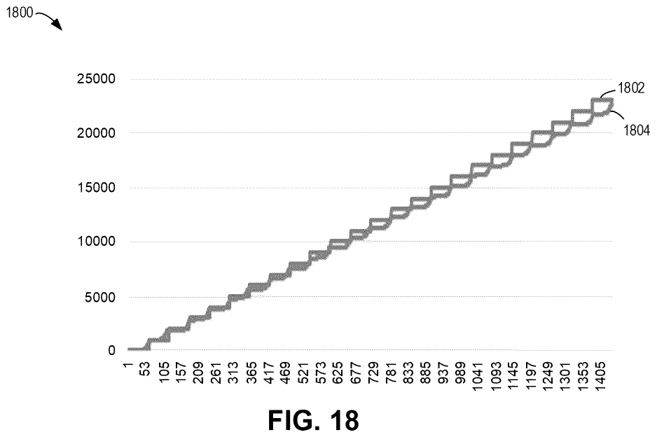

FIG. 18 illustrates still another experimental result 1800 about the total number of synchronization rounds according to an embodiment of the present disclosure. In the diagram of total number of synchronization rounds, the number of synchronization rounds of an adaptive method 1802 implemented according to the present disclosure is always higher than that of a fixed replication bandwidth method 1804. More completed cycles of synchronization will result in more consistent data, and more consistent data recovery in the event of a disaster.

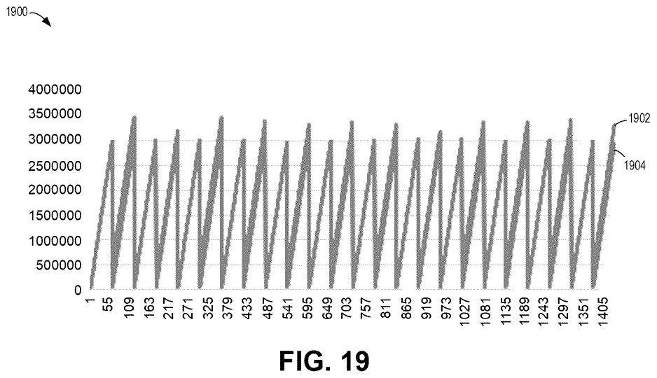

FIG. 19 illustrates still another experimental result 1900 about a total IO amount of a front-end host on a source site according to an embodiment of the present disclosure. The total cumulative host IO data of an adaptive method 1904 implemented according to the embodiments of the present disclosure is almost equal to that of a fixed replication bandwidth method 1902, and they have consistent performance for this situation without any degradation.

The following table may be determined based on the above experimental data

| | | | | | Increased |
|---|---|---|---|---|---|
| | Reduced | Reduced | Increased | Increased | number of |
| | lost | cumulative | synchronization | bandwidth | synchronization |
| Item | RPO | host io | data | usage | rounds |
| 1000_5min_gt_1.2_bw_2h | 50.45% | 18.97% | 28.02% | 30.60% | 27.95% |
| 1000_5min_lt_0.8_bw_2h | 0.00% | 0.00% | 0.00% | −4.73% | 0.00% |
| 1000_5min_eq_1.0_bw_2h | 100.00% | 10.26% | 1.72% | 3.04% | 1.70% |

It may be determined from the above data that, for the overall situation, the adaptive replication bandwidth solutions implemented according to some embodiments of the present disclosure have consistent positive performance improvements across a variety of replication performance metrics. The method implemented according to the embodiments of the present disclosure has 100.00% improvement in reducing the lost RPO event count. The method implemented according to the embodiments of the present disclosure has 18.97% improvement in reducing the cumulative host IOs of the RPO window. The method implemented according to the embodiments of the present disclosure has 28.02% improvement in increasing the synchronization data amount. The method implemented according to the embodiments of the present disclosure has 30.60% improvement in the synchronization bandwidth usage rate.

The method implemented according to the embodiments of the present disclosure has 27.95% improvement in increasing the number of synchronization rounds. In general, the method implemented according to the embodiments of the present disclosure may provide a solution for guaranteeing service for critical replication business. Providing the proactive ability to adaptively set replication bandwidth at each replicated storage object will ensure the maximum consistency of their critical replicated data over their lifetime. Moreover, it expands the scope of the ability of the service provider to set adaptive protection rules on the storage object based on the content consumed. This will also ensure receiving the expected performance.

Finally, with the increasing demand for data protection of cloud services, replication becomes more important, and the method implemented according to the embodiments of the present disclosure may provide protection as a service. The method implemented according to the embodiments of the present disclosure allows for management and control of performance predictability and consistency within a device.

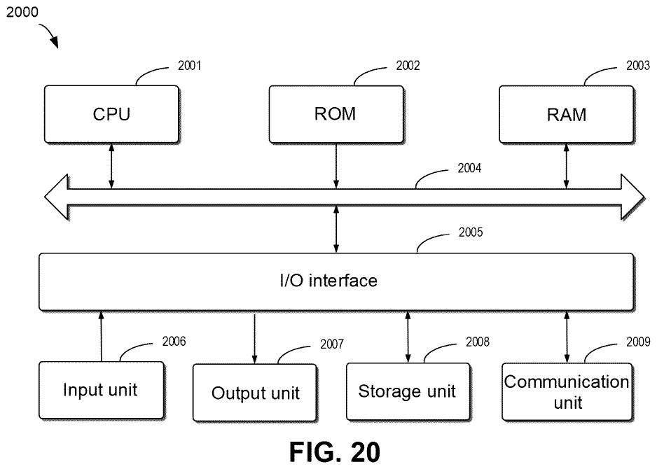

FIG. 20 is a schematic block diagram of an example device 2000 that can be used to implement an embodiment of the present disclosure. The terminal device in FIG. 1 can be implemented using the device 2000. As shown in the figure, the device 2000 includes a central processing unit (CPU) 2001 that may execute various appropriate actions and processing according to computer program instructions stored in a read-only memory (ROM) 2002 or computer program instructions loaded from a storage unit 2008 to a random access memory (RAM) 2003. Various programs and data required for operations of the device 2000 may also be stored in the RAM 2003. The CPU 2001, the ROM 2002, and the RAM 2003 are connected to each other through a bus 2004. An Input/Output (I/O) interface 2005 is also connected to the bus 2004.

The plurality of components in the device 2000 are connected to the I/O interface 2005, including: an input unit 2006 such as a keyboard and a mouse; an output unit 20020 such as various types of displays and speakers; a storage page 2008 such as a magnetic disk and an optical disc; and a communication unit 2009 such as a network card, a modem, and a wireless communication transceiver. The communication unit 2009 allows the device 2000 to exchange information/data with other devices via a computer network such as the Internet and/or various telecommunication networks.

The various processes and processing described above, such as the method 200, may be performed by the processing unit 2001. For example, in some embodiments, the method 200 may be implemented as a computer software program that is tangibly included in a machine-readable medium, such as the storage unit 2008. In some embodiments, part or all of the computer program may be loaded and/or installed onto the device 2000 via the ROM 2002 and/or the communication unit 2009. When the computer program is loaded into the RAM 2003 and executed by the CPU 2001, one or more actions of the method 200 described above may be implemented.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device that may hold and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any appropriate combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or more programming languages, the programming languages including object-oriented programming languages such as Smalltalk, C++, or the like, and conventional procedural programming languages such as the C language or similar programming languages. The computer-readable program instructions may be executed entirely on a user's computer, partly on a user's computer, as a stand-alone software package, partly on a user's computer and partly on a remote computer, or entirely on a remote computer or a server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described here with reference to flow charts and/or block diagrams of the method, the apparatus (system), and the computer program product implemented according to the embodiments of the present disclosure. It should be understood that each block of the flow charts and/or block diagrams and combinations of blocks in the flow charts and/or block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means (e.g., specialized circuitry) for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a special hardware-based system that executes specified functions or actions, or using a combination of special hardware and computer instructions.

Various embodiments of the present disclosure have been described above. The foregoing description is by way of example and not exhaustive, and is not intended to be limited to the disclosed embodiments. Numerous modifications and alterations are apparent to persons of ordinary skill in the art without departing from the scope and spirit of the illustrated embodiments. The selection of terms as used herein is intended to best explain the principles and practical applications of the various embodiments or technical improvements to technologies on the market, or to enable other persons of ordinary skill in the art to understand the embodiments disclosed here.

1. A method for data replication, comprising:
determining a total replication bandwidth based on a plurality of replication sessions, wherein the plurality of replication sessions are used to replicate data;
comparing the total replication bandwidth with a replication link bandwidth;
prioritizing, in response to the total replication bandwidth being greater than the replication link bandwidth, the plurality of replication sessions based on one or more of a user-defined priority, a differential data priority, a data change rate priority, a replication progress priority, a replication session start time priority, and a lost recovery point objective (RPO) priority; and
performing the data replication based on the plurality of ranked replication sessions.

2. The method according to claim 1, wherein the prioritizing the plurality of replication sessions comprises:
prioritizing and scoring the plurality of replication sessions based on the user-defined priority;
wherein the user-defined priority comprises at least a first user-defined priority, a second user-defined priority, and a third user-defined priority;
wherein a first user-defined priority score of a replication session having the first user-defined priority is higher than a first user-defined priority score of a replication session having the second user-defined priority; and
a user-defined priority score of the replication session having the second user-defined priority is higher than a user-defined priority score of a replication session having the third user-defined priority.

3. The method according to claim 1, wherein the prioritizing the plurality of replication sessions further comprises:
prioritizing and scoring the plurality of replication sessions based on the differential data priority;
wherein the differential data represents a portion of data in which the plurality of replication sessions change relative to a previous replication cycle in the data replication, and the differential data priority comprises at least a first differential data priority and a second differential data priority;
wherein differential data of the plurality of replication sessions having the first differential data priority is less than differential data of the plurality of replication sessions having the second differential data priority; and
wherein a differential data priority score of the plurality of replication sessions having the first differential data priority is less than a differential data priority score of the plurality of replication sessions having the second differential data priority.

4. The method according to claim 1, wherein the prioritizing the plurality of replication sessions further comprises:
prioritizing and scoring the plurality of replication sessions based on the data change rate priority;
wherein a data change rate represents a data write rate in the data replication, and the data change rate priority comprises at least a first data change rate priority and a second data change rate priority;
wherein a data write rate of the plurality of replication sessions having the first data change rate priority is less than a data write rate of the plurality of replication sessions having the second data change rate priority; and
wherein a data change rate priority score of the plurality of replication sessions having the first data change rate priority is less than a data change rate priority score of the plurality of replication sessions having the second data change rate priority.

5. The method according to claim 1, wherein the prioritizing the plurality of replication sessions further comprises:
prioritizing and scoring the plurality of replication sessions based on the replication progress priority;
wherein a replication progress represents a replication completion degree in the data replication, and the replication progress priority comprises at least a first replication progress priority and a second replication progress priority;
wherein a data replication completion degree of the plurality of replication sessions having the first replication progress priority is less than a data replication completion degree of the plurality of replication sessions having the second replication progress priority; and
wherein a replication progress priority score of the plurality of replication sessions having the first replication progress priority is less than a replication progress priority score of the plurality of replication sessions having the second replication progress priority.

6. The method according to claim 1, wherein the prioritizing the plurality of replication sessions further comprises:
prioritizing and scoring the plurality of replication sessions based on the replication session start time priority;
wherein a replication session start time represents a replication start time in the data replication, and the plurality of replication session start time priorities comprise at least a first replication session start time priority and a second replication session start time priority;
wherein a replication session start time of the plurality of replication sessions having the first replication session start time priority is later than a replication session start time of the plurality of replication sessions having the second replication session start time priority; and
wherein a replication session start time priority score of the plurality of replication sessions having the first replication session start time priority is less than a replication session start time priority score of the plurality of replication sessions having the second replication session start time priority.

7. The method according to claim 1, wherein the prioritizing the plurality of replication sessions further comprises:
prioritizing and scoring the plurality of replication sessions based on the lost recovery point objective (RPO) priority;
wherein a lost RPO represents a maximum time window in which data loss is allowed in the data replication, and the lost RPO priority comprises at least a first lost RPO priority and a second lost RPO priority;
wherein a lost RPO count of the plurality of replication sessions having the first lost RPO priority is less than a lost RPO count of the plurality of replication sessions having the second lost RPO priority; and
wherein a lost RPO priority score of the plurality of replication sessions having the first lost RPO priority is less than a lost RPO priority score of the plurality of replication sessions having the second lost RPO priority.

8. The method according to claim 1, wherein the prioritizing the plurality of replication sessions further comprises:
determining a total priority score for the plurality of replication sessions based on one or more of a user-defined priority score, a differential data priority score, a data change rate priority score, a replication progress priority score, a replication session start time priority score, and a lost RPO priority score.

9. The method according to claim 8, further comprising:
ranking, in response to the total replication bandwidth being greater than the replication link bandwidth, the plurality of replication sessions in descending order based on the total priority score; and
allocating the replication link bandwidth based on a ranking of each replication session in the plurality of replication sessions ranked in descending order.

10. An electronic device, comprising:
at least one processor; and
a memory coupled to the at least one processor and having instructions stored therein, wherein the instructions, when executed by the at least one processor, cause the electronic device to perform actions comprising:
determining a total replication bandwidth based on a plurality of replication sessions, wherein the plurality of replication sessions are used to replicate data;
comparing the total replication bandwidth with a replication link bandwidth;
prioritizing, in response to the total replication bandwidth being greater than the replication link bandwidth, the plurality of replication sessions based on one or more of a user-defined priority, a differential data priority, a data change rate priority, a replication progress priority, a replication session start time priority, and a lost recovery point objective (RPO) priority; and
performing the data replication based on the plurality of ranked replication sessions.

11. The electronic device according to claim 10, wherein the prioritizing the plurality of replication sessions comprises:
prioritizing and scoring the plurality of replication sessions based on the user-defined priority;
wherein the user-defined priority comprises at least a first user-defined priority, a second user-defined priority, and a third user-defined priority;
wherein a first user-defined priority score of a replication session having the first user-defined priority is higher than a first user-defined priority score of a replication session having the second user-defined priority; and
a user-defined priority score of the replication session having the second user-defined priority is higher than a user-defined priority score of a replication session having the third user-defined priority.

12. The electronic device according to claim 10, wherein the prioritizing the plurality of replication sessions further comprises:
prioritizing and scoring the plurality of replication sessions based on the differential data priority;
wherein the differential data represents a portion of data in which the plurality of replication sessions change relative to a previous replication cycle in the data replication, and the differential data priority comprises at least a first differential data priority and a second differential data priority;
wherein differential data of the plurality of replication sessions having the first differential data priority is less than differential data of the plurality of replication sessions having the second differential data priority; and
wherein a differential data priority score of the plurality of replication sessions having the first differential data priority is less than a differential data priority score of the plurality of replication sessions having the second differential data priority.

13. The electronic device according to claim 10, wherein the prioritizing the plurality of replication sessions further comprises:
prioritizing and scoring the plurality of replication sessions based on the data change rate priority;
wherein a data change rate represents a data write rate in the data replication, and the data change rate priority comprises at least a first data change rate priority and a second data change rate priority;
wherein a data write rate of the plurality of replication sessions having the first data change rate priority is less than a data write rate of the plurality of replication sessions having the second data change rate priority; and
wherein a data change rate priority score of the plurality of replication sessions having the first data change rate priority is less than a data change rate priority score of the plurality of replication sessions having the second data change rate priority.

14. The electronic device according to claim 10, wherein the prioritizing the plurality of replication sessions further comprises:
prioritizing and scoring the plurality of replication sessions based on the replication progress priority;
wherein a replication progress represents a replication completion degree in the data replication, and the replication progress priority comprises at least a first replication progress priority and a second replication progress priority;
wherein a data replication completion degree of the plurality of replication sessions having the first replication progress priority is less than a data replication completion degree of the plurality of replication sessions having the second replication progress priority; and
wherein a replication progress priority score of the plurality of replication sessions having the first replication progress priority is less than a replication progress priority score of the plurality of replication sessions having the second replication progress priority.

15. The electronic device according to claim 10, wherein the prioritizing the plurality of replication sessions further comprises:
prioritizing and scoring the plurality of replication sessions based on the replication session start time priority;
wherein a replication session start time represents a replication start time in the data replication, and the plurality of replication session start time priorities comprise at least a first replication session start time priority and a second replication session start time priority;
wherein a replication session start time of the plurality of replication sessions having the first replication session start time priority is later than a replication session start time of the plurality of replication sessions having the second replication session start time priority; and
wherein a replication session start time priority score of the plurality of replication sessions having the first replication session start time priority is less than a replication session start time priority score of the plurality of replication sessions having the second replication session start time priority.

16. The electronic device according to claim 10, wherein the prioritizing the plurality of replication sessions further comprises:
prioritizing and scoring the plurality of replication sessions based on the lost recovery point objective (RPO) priority;
wherein a lost RPO represents a maximum time window in which data loss is allowed in the data replication, and the lost RPO priority comprises at least a first lost RPO priority and a second lost RPO priority;
wherein a lost RPO count of the plurality of replication sessions having the first lost RPO priority is less than a lost RPO count of the plurality of replication sessions having the second lost RPO priority; and
wherein a lost RPO priority score of the plurality of replication sessions having the first lost RPO priority is less than a lost RPO priority score of the plurality of replication sessions having the second lost RPO priority.

17. The electronic device according to claim 10, wherein the prioritizing the plurality of replication sessions further comprises:
determining a total priority score for the plurality of replication sessions based on one or more of a user-defined priority score, a differential data priority score, a data change rate priority score, a replication progress priority score, a replication session start time priority score, and a lost RPO priority score.

18. The electronic device according to claim 17, further comprising:
ranking, in response to the total replication bandwidth being greater than the replication link bandwidth, the plurality of replication sessions in descending order based on the total priority score; and
allocating the replication link bandwidth based on a ranking of each replication session in the plurality of replication sessions ranked in descending order.

19. A computer program product having a non-transitory computer readable medium which stores a set of instructions to replicate data; the set of instructions, when carried out by computerized circuitry, causing the computerized circuitry to perform a method of:
determining a total replication bandwidth based on a plurality of replication sessions, wherein the plurality of replication sessions are used to replicate data;
comparing the total replication bandwidth with a replication link bandwidth;
prioritizing, in response to the total replication bandwidth being greater than the replication link bandwidth, the plurality of replication sessions based on one or more of a user-defined priority, a differential data priority, a data change rate priority, a replication progress priority, a replication session start time priority, and a lost recovery point objective (RPO) priority; and
performing data replication based on the plurality of ranked replication sessions.

20. The computer program product according to claim 19, wherein the prioritizing the plurality of replication sessions comprises:
prioritizing and scoring the plurality of replication sessions based on the user-defined priority;
wherein the user-defined priority comprises at least a first user-defined priority, a second user-defined priority, and a third user-defined priority;
wherein a first user-defined priority score of a replication session having the first user-defined priority is higher than a first user-defined priority score of a replication session having the second user-defined priority; and
a user-defined priority score of the replication session having the second user-defined priority is higher than a user-defined priority score of a replication session having the third user-defined priority.
